(19) United States
(12) Patent Application Publication
(10) Pub. No.: US 2008/0134839 A1
(43) Pub. Date: Jun. 12, 2008

(54) Valve Assembly Extraction Tool

(76) Inventors: Ian Anderson, Cambridge (GB); Clive Graham Angel, Herts (GB)

Correspondence Address: Levy & Grandinetti, P.O. Box 18385, Washington, DC, 20036, US

(21) Appl. No.: 11/596,984

(22) PCT Filed: May 20, 2005
(86) PCT No.: PCT/IB05/01383

§ 371 Date: Aug. 15, 2007

(30) Foreign Application Priority Data
May 21, 2004 (GB) 0411409.6

(51) Int. Cl. B67B 7/42; B67D 1/08

(52) U.S. Cl. 81/3.55; 29/267

(57) ABSTRACT

There is disclosed a tool (50) for extracting a valve assembly (16) from a container (10). The tool preferably had three gripper ring segments (52) adapted to move between a closed ring engaging position and a non-engaging position with the valve assembly (16). The tool has one lever assembly (60) for each gripper ring segment. Each lever assembly has a lever having a first end portion (64) connected with a corresponding one of the ring segments (52) to move the corresponding ring segment between the engaging and non-engaging positions with the valve assembly. The tool has an actuation mechanism (90) connected with the levers to move the levers in synchronism and thereby move the gripper ring segments into engagement with the valve assembly. The actuator pulls the valve assembly from the container via the levers and gripper ring segments with the gripper ring segments in the engaging position.

### FIELD OF THE INVENTION

The present invention relates to a valve assembly extraction tool for removing a valve assembly from an alcohol beverage container.

### BACKGROUND OF THE INVENTION

It is known to contain alcohol and beer in a container or a keg. In the case of a beer keg, pressure is applied to a beer containing bag housed within the keg to dispense beer through a valve body assembly from the bag contained in the keg.

Typically the valve assembly is mounted in the container by a press fit within an aperture of the container. The valve assembly controls the filling and dispensing of fluids from the bag and also controls the pressures in the container and the bag. The valve assembly can be a relatively expensive component that can be cleaned and reused after each use. To reuse the valve assembly, it must be removed from the container in a manner which does not damage the valve assembly. The valve assembly typically has a flexible rubber over-moulded bung that compresses to allow the valve assembly to be extracted from the container. However, there is still a need to develop a tool that effectively supports and extracts the valve assembly from the container without damaging the valve assembly or the container.

In any case, for re-usable kegs, a spent-valve assembly must be removed in order for the keg to be cleaned and re-used. This is particularly the case in bag-in-keg dispense systems.

### SUMMARY OF THE INVENTION

The present invention relates to a tool for extracting a valve assembly from a container. The container is preferably a beer keg. The tool has a plurality of gripper ring segments adapted to move between a closed ring engaging position and a non-engaging position with the valve assembly. The tool has a plurality of lever assemblies, one for each gripper ring segment. Each lever assembly comprises a lever having a first end portion connected with a corresponding one of the ring segments to move the corresponding ring segment between the engaging and non-engaging positions with the valve assembly. The tool has an actuating mechanism connected with the levers to move the levers in synchronism and thereby move the gripper ring segments into engagement with the valve assembly. The actuator pulls the valve assembly from the container via the levers and gripper ring segments in the engaging position.

It should be understood that in the practice of the present invention at least two levers and corresponding gripper ring segments are required in order to provide proper leverage to pull or extract the valve assembly. Preferably three levers and three gripper ring segments of same size are spaced at equal angles axially about the axis of the valve assembly.

In one embodiment, the lever assemblies each comprise a support block adapted to engage the valve assembly to orient the lever assembly with the valve assembly. The support block is pivotally connected with the lever. The actuator mechanism pivots the lever relative to the support block to move the first end portion of the lever towards the valve assembly and thereby move the corresponding gripper ring segment into the engaging position with the valve assembly.

In one embodiment, the lever has a curving second end portion with a widening end and the actuating mechanism comprises a beam support. The beam support has one leg for each lever assembly and is movable vertically in downward and upward strokes. A pair of roller pins are mounted on each leg for supporting therebetween in sliding relation the second end portion of a corresponding lever. A downward stroke of the beam support moves the support block into engagement with the valve assembly and moves the roller pins along the second end portion of the lever to pivot the lever relative to the support block thereby moving the first end portion of the lever and corresponding gripper ring segment radially outward of the valve assembly. Further, on the upward stroke of the beam assembly, the roller pins move upwardly along the second end portion of the lever to pivot the lever arm relative to the support block to move the first end portion of the lever radially inward of the valve assembly to thereby bring the corresponding gripper ring segment into engagement with the valve assembly. Vertical movement of the roller pins relative to the second end portion of the lever stops when the roller pins engage the widened end of the lever. When the roller pins engage the widened end of the lever the continuing upward stroke causes the roller pins to pull the lever and lift the gripper ring segment and thereby remove the valve assembly from the container.

### BRIEF DESCRIPTION OF THE DRAWINGS

For a better understanding of the nature and objects of the present invention reference may be had to the accompanying diagrammatic drawings in which:

FIG. 1 is a split sectional view of a valve assembly extraction tool of the present invention showing the lever assembly and gripper ring segments in engaging and non-engaging positions with the keg;

FIG. 2 is a sectional view of the valve assembly shown extracted from the keg; and,

FIG. 3 is a plan view of the valve assembly extraction tool.

### DETAILED DESCRIPTION OF THE INVENTION

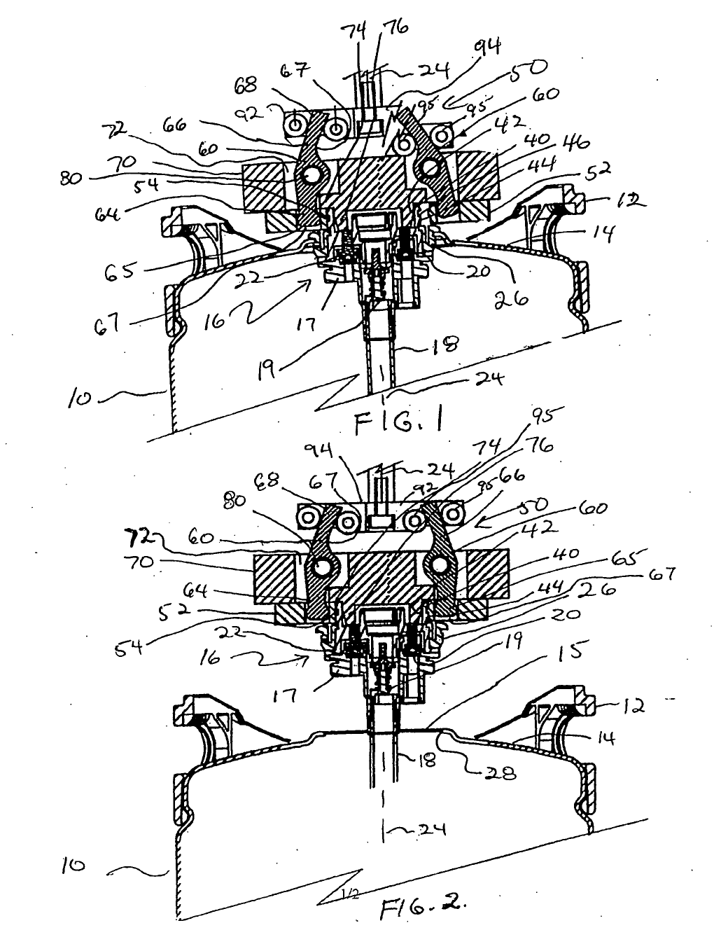

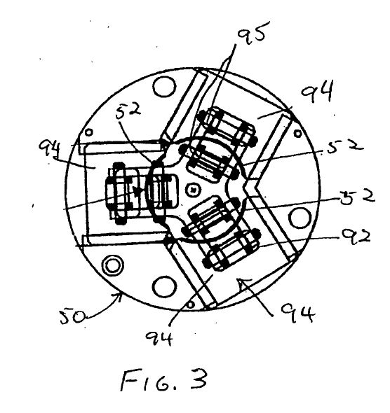

Referring to FIGS. 1 and 2 there is shown an upper portion of an alcohol container or beer keg 10 having a chime 12 attached thereto. The container 10 has a top wall 14. The top wall 14 has a central opening 15 for receiving a valve body assembly 16.

The valve body assembly 16 has a hub 17 to which is connected a central spear 18 that extends into a bag (not shown). Alcohol or beer passes through valve 19 in the hub 17 and through the spear 18 into and out of the bag. The hub 17 of the valve body assembly 16 further includes additional valves 20 and 22 respectively used to pressurize the bag and the inside of the keg 10. The valve assembly 16 is shown oriented along a vertical extending axis 24.

The valve body assembly 16 has a flexible rubber keg bung 26 moulded thereto that interconnects the hub 17 at the edge 28 of the central opening 15. The valve assembly 16 is constructed with an annular upper ring lip 40 having inner wall 42 and outer wall 44. The outer wall 44 has an annular groove 46 to facilitate the removal of the valve assembly 16 from the container 10.

It should be understood that in the embodiments shown in FIGS. 1 and 2, an anti-tamper ring (not shown) has been removed from the valve assembly 16 and container 10. The anti-tamper ring typically covers a portion of the top keg surface 14 and a portion of the valve body assembly 16. This anti-tamper ring is removed by an anti-tamper ring extraction tool prior to the valve assembly 16 being extracted from the container 10.

It should be further understood that FIG. 1 illustrates the valve assembly extraction tool 50 in split views. That is the right hand side of FIG. 1 shows the valve assembly extraction tool 50 in a position about to engage the valve assembly 16. The left hand side of FIG. 1 shows the position where the extraction tool 50 engages the valve assembly 16. With respect to FIG. 2, this Figure shows the valve assembly 16 removed from the container 10 with the extraction tool 50 engaging the valve assembly 16.

Referring to FIGS. 1 through 3, the tool 50 comprises three gripper rings segments 52 of equal size that are spaced apart around the axis 24 of the valve assembly by 120°. The three gripper ring segments 52 are adapted to move between a non-engaging position with the valve assembly 16 shown on the right of FIG. 1, and in FIG. 3, into an engaging position shown on the left of FIG. 1, and in FIG. 2, with the valve assembly 16. In the non-engaging position as shown in FIG. 3, the ring segments 52 do not form a complete circle because they are spaced radially outward from the valve assembly 16. However, in the engaging position, the ring segments 52 are moved radially inward to complete or close a circular pattern surrounding the valve assembly 16. The gripper ring segments 52 comprise metal plates that have protrusions 54 that matingly engage with the groove 46 of the valve assembly 16 when the gripper ring segment 52 is in its engaging position.

The tool 50 comprises at least one lever assembly 60 for each gripper ring segment 52. Accordingly each lever assembly 60 is spaced at 120° intervals about the axis 24 of the valve assembly 16. Each lever assembly 60 has a lever 62. Lever 62 has a first end portion 64 that is connected with a corresponding one of the ring segments 52. The first end portion 64 moves the corresponding one ring segment 52 between the engaging and non-engaging positions with the valve assembly 16. The first end portion 64 has a first widened end section 65 that sits within recessed openings 67 of the gripper ring segment 52. The first widened end portion 65 carries the gripper ring segment 52. The movement of this first end portion 64 effects the movement of the gripper ring segment 52. The lever 62 has a curving second end portion 67 with a second widening end 68. Each of the lever assemblies 60 has a support block 70 which comprises a metal plate with an aperture 72 within or through which the lever 62 extends. The lever 62 is pivotally mounted at 80 relative to the support block 70. The support block 70 further has first and second flanges 74 and 76 that respectively abut the top of the upper ring lip 40 of the valve assembly 16 and the inner wall 42 of the upper ring lip 40. With the engagement of these flanges 74 and 76 of the support block 70 with the valve assembly 16, the support block 70 is orientated relative to the valve assembly 16 and supports the inner wall 42 of the valve assembly 16.

The lever 62 and corresponding gripper ring segments 52 are moved in synchronism into engagement with the valve assembly 16 by an actuating mechanism 90. The actuating mechanism 90 comprises a beam support 92 having legs 94 (see FIG. 3), one for each lever assembly 60. The beam support 90 is movable horizontally in upward and downward strokes by means of a piston (not shown). Each leg 94 of the beam support 90 has a pair of roller pins 95 mounted thereto for supporting therebetween, in sliding into relation therewith the second end portion 66 of the lever 62.

As the actuating member 90 is moved in a downward stroke position as represented by the position shown on the left of FIG. 1, the supporting block 70 moves into supporting engagement with the valve assembly 16 whereby the flanges 74 and 76 orient the block 70 relative to the valve assembly 16. In this position, the actuating mechanism 90 has effectively moved the levers 62 radially outward away from the central axis 24 of the valve assembly.

To remove the valve assembly 16, the actuating mechanism 90 is moved in an upward stroke. During initial movement of the beam support 92 in the upward stroke, the roller pins 95 move upwardly sliding along the curved second end portion of the lever 62 so as to pivot the lever arm 62 about pivot 80 relative to the support block 70 and move its first end portion 64 radially inward of the valve assembly 16 to bring the gripper rings segment 52 into engagement with the valve assembly 16. The initial vertical movement of the roller pins 95 results in lost vertical motion of the lever 62 and is translated to radial inward movement of the first end portion 64 of the lever 62. In this engaged position, the protruding portion 54 of the gripper ring segment 52 matingly engages with the recessed groove 46 of the lip portion 40 of the valve assembly 16.

As the upward stroke of beam support 92 continues, the roller pins 95 engage the second widening end 68 of the lever 62 as shown in FIG. 2. In this position the roller pins 95 can no longer travel vertically upward without pulling the pins lever 62 vertically upward. As a result, the continued upward stroke of the beams support 92 results in the roller pins 95 pulling on the levers 62 and gripper ring segments 52 vertically upward to remove the valve assembly 16 from the container 12. Due to the forces applied, the flexible bung 26 compresses to permit the removal of the valve assembly 16.

By provisions of the above mentioned extraction tool for a valve assembly, there is provided a mechanism which effectively removes the valve assembly from a container without damaging the valve assembly and simultaneously supports both the inside and outside portions of the valve assembly to which the gripper force is applied.

What is claimed is:

1. A tool for extracting a valve assembly from a container, the tool comprising:
a plurality of gripper ring segments adapted to move between a closed ring engaging position and a non-engaging position with the valve assembly;
a lever assembly for each one of the gripper ring segments, each lever assembly comprising a lever having a first end portion connected with a corresponding one of the gripper ring segments to move the corresponding gripper ring segment between the engaging and non-engaging positions with the valve assembly; and,
an actuating mechanism connected with the levers to move the levers in synchronism and thereby move the gripper ring segments into engagement with the valve assembly, and the actuator mechanism pulling the valve assembly from the container via the levers and gripper ring segments in the engaging position.

2. The tool of claim 1 wherein each of the lever assemblies comprises a support block adapted to engage the valve assembly to orient the lever assembly with the valve assembly, the support block being pivotally connected with the lever, and the actuator mechanism pivoting the lever relative to the support block to move the first end portion of the lever towards the valve assembly and thereby move the corresponding gripper ring segment into the engaging position with the valve assembly.

3. The tool of claim 2 wherein the valve assembly has an annular upper ring lip having inner and outer walls and wherein the support block supports and engages the inner wall of the upper ring lip and the corresponding gripper ring segment engages the outer wall of the upper ring lip.

4. The tool of claim 3 wherein the outer wall of the valve assembly has a groove and the gripper ring segment has a protrusion that matingly engages with the groove when the gripper ring segment is in the engaging position.

5. The tool of claim 1 wherein the valve assembly has a central axis and the tool includes three levers spaced axially around the central axis.

6. The tool of claim 2 wherein the lever has a curving second end portion with a widening end, and the actuating mechanism comprises:
a beam support movable horizontally in downward and upward strokes and having one leg for each lever assembly;
a pair of roller pins mounted on each leg for supporting therebetween in sliding relation the second end portion of a corresponding lever;
whereby a downward stroke of the beam support moves the support block into engagement with the valve assembly and moves the roller pins along the second end portion of the lever to pivot the lever relative to the support block moving the first end portion of the lever radially outward of the valve assembly; and,
whereby on an upward stroke of the beam assembly the roller pins move vertically upward and slide along the second end portion of the lever to pivot the lever arm relative to the support block to move the first end portion of the lever radially inward of the valve assembly and bring the gripper ring segment into engagement with the valve assembly, and the roller pins engaging the widening end of the lever to lift the lever and gripper ring segment to thereby remove the valve assembly from the container.
